(19) United States
(12) Patent Application Publication
(10) Pub. No.: US 2025/0019084 A1
(43) Pub. Date: Jan. 16, 2025

(54) THERMAL MANAGEMENT SYSTEM AND METHOD FOR AIRCRAFT FUEL CELLS

(71) Applicant: Joby Aero, Inc., Santa Cruz, CA (US)

(72) Inventors: Robert Gulliver Lynn, Auckland (NZ); Jeffrey Allen Lotterman, Los Angeles, CA (US); Gregor Veble Mikic, Santa Cruz, CA (US); Benjamin Brelje, Ann Arbor, MI (US)

(21) Appl. No.: 18/398,764

(22) Filed: Dec. 28, 2023

Related U.S. Application Data
(60) Provisional application No. 63/477,489, filed on Dec. 28, 2022.

(51) Int. Cl. B64D 33/08; B64D 13/02; B64D 27/355

(52) U.S. Cl. CPC B64D 33/08; B64D 13/02; B64D 27/355

(57) ABSTRACT

A fuel cell thermal management system and method for aerodynamic vehicles (such as aircraft) having propulsion systems powered by hydrogen fuel cells. The system and method reduce the overall amount of energy required to operate a propulsion system, which in turn reduces cooling requirements and improves efficiency. A cabin air reuse system uses cabin exhaust air as input air for the fuel cell. Because the cabin exhaust air is compressed, this saves the work involved in compressing air for input to the fuel cell.

### RELATED APPLICATION DATA

This application claims the benefit of U.S. Provisional Patent Application No. 63/477,489 filed on Dec. 28, 2022, the contents of which are incorporated herein by reference as if explicitly set forth.

### TECHNICAL FIELD

This invention relates generally to the field of hydrogen fuel cell systems, and, more specifically, to thermal management of hydrogen fuel cell systems on aerodynamic vehicles such as electrically-powered or hybrid-powered aircraft.

### BACKGROUND

A fuel cell is an electrochemical cell that converts the chemical energy of a fuel (often hydrogen) and an oxidizing agent (often oxygen) into electricity through a pair of redox reactions. Fuel cells have been used to generate electrical power in many applications. Fuel cells are used for primary and backup power for commercial, industrial, and residential buildings and in remote or inaccessible areas. They are also used to power fuel cell vehicles, including forklifts, automobiles, buses, trains, boats, motorcycles, and submarines.

Fuel cell vehicles are powered by hydrogen that is fed into an onboard fuel cell “stack,” which transforms the hydrogen's chemical energy into electrical energy. This electricity is then available to power the vehicle and its onboard systems.

Hydrogen supplied to a fuel cell enters the anode, where it comes in contact with a catalyst that promotes the separation of hydrogen atoms into an electron and proton. The electrons are gathered by the conductive current collector, which is connected to the vehicle's high-voltage circuitry, feeding an onboard battery and/or electric motors that propel the vehicle. The byproduct of the reaction occurring in the fuel cell stack is water vapor, which is emitted through an exhaust.

Also included in fuel cell powered vehicles is a “balance-of-plant,” which contains all of the other components of a fuel cell system except the stack itself. This includes pumps, sensors, heat exchanger, gaskets, compressors, recirculation blowers or humidifiers, and so forth.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a plan view of an aerodynamic vehicle in the form of an aircraft according to some examples of this disclosure.

FIG. 2 is a schematic view of an energy supply system for an aerodynamic vehicle (such as an aircraft) according to some examples of this disclosure.

FIG. 3 is a schematic diagram of a fuel cell thermal management system according to some examples of this disclosure.

FIG. 4 is a schematic diagram of the cabin air reuse system portion of the fuel cell thermal management system according to some examples of this disclosure.

FIG. 5 is a flow diagram illustrating the details of a fuel cell thermal management method according to some examples of this disclosure.

FIG. 6 illustrates a diagrammatic representation of a machine in the form of a computer system within which a set of instructions may be executed for causing the machine to perform any one or more of the methodologies discussed herein, according to an example.

### DETAILED DESCRIPTION

The following description of examples of the invention is not intended to limit the invention to these examples, but rather to enable any person skilled in the art to make and use this invention.

### General Overview

Hydrogen fuel cells, as well as other types of non-combustion turbine propulsion power systems, have large cooling requirements. This can make designing a cooling system for fuel cells on aerodynamic vehicles quite challenging. As used herein, the phrase “aerodynamic vehicle” includes vehicles moving through air that are affected by aerodynamics forces. This includes aircraft and automobiles. In examples where the aerodynamic vehicle is an aircraft, cooling the one or more fuel cells powering an electric or hybrid aircraft may be done with air.

The fuel cell thermal management system and method described herein reduces the overall amount of energy required to operate a propulsion system on an aerodynamic vehicle, particularly aircraft. This reduces the cooling requirement for the fuel cell. A cabin air reuse system uses cabin exhaust air as input air for the fuel cell. Because the cabin exhaust air is at least somewhat compressed, this saves the work involved in compressing air for input to the fuel cell.

At altitudes where pressurization is needed, a compressor provides pressurized air for the aircraft cabin. The air within the cabin is continually exchanged for new air from the compressor, and the old air is exhausted from the cabin. This cabin exhaust air typically contains a small amount of carbon dioxide (CO₂). The cabin air reuse system takes this cabin exhaust air and use it as input air to the stack of fuel cells, or fuel cell stack. This avoids wasting additional energy compressing air. Instead of dumping this cabin exhaust air, which contains most of the oxygen put into the cabin, it is reused in the fuel cell stack. This increases the overall efficiency by reducing the amount of air that needs to be compressed, thereby reducing the cooling requirements for the compressor, which avoid having to compress additional air for the fuel cell stack.

### DESCRIPTION

FIG. 1 is a plan view of an aerodynamic vehicle in the form of an aircraft 100 according to some examples. The aircraft 100 includes a fuselage 114, two wings 112, an empennage 110, and propulsion systems 108 embodied as ducted fans or rotor assemblies 116 located in nacelles 102. The aircraft 100 includes one or more fuel cell stacks embodied in FIG. 1 as nacelle fuel cell stacks 104 and wing fuel cell stacks 106. One or more heat exchangers 120 are located in the wings 112, the fuselage 114, nacelles 102, or other locations. It should be noted that the fuel cell stacks 104, 106 and heat exchangers 120 in some examples are positioned in locations other than those shown in FIG. 1. For instance, in some examples, the fuel cell stacks and heat exchangers are located in one or more of the leading edges of wings or other aerosurfaces, wing nacelles, fuselage noses or in scoops sticking out from the sides of aircraft fuselages, wings, or nacelles.

The aircraft 100 will also typically include associated equipment such as an electronic infrastructure, control surfaces, a cooling system, landing gear and so forth. The wings 112 function to generate lift to support the aircraft 100 during forward flight. In some examples the wings 112 can additionally or alternately function to structurally support the fuel cell stacks 104, 106 and/or propulsion systems 108 under the influence of various structural stresses (e.g., aerodynamic forces, gravitational forces, propulsive forces, external point loads, distributed loads, and/or body forces, and so forth).

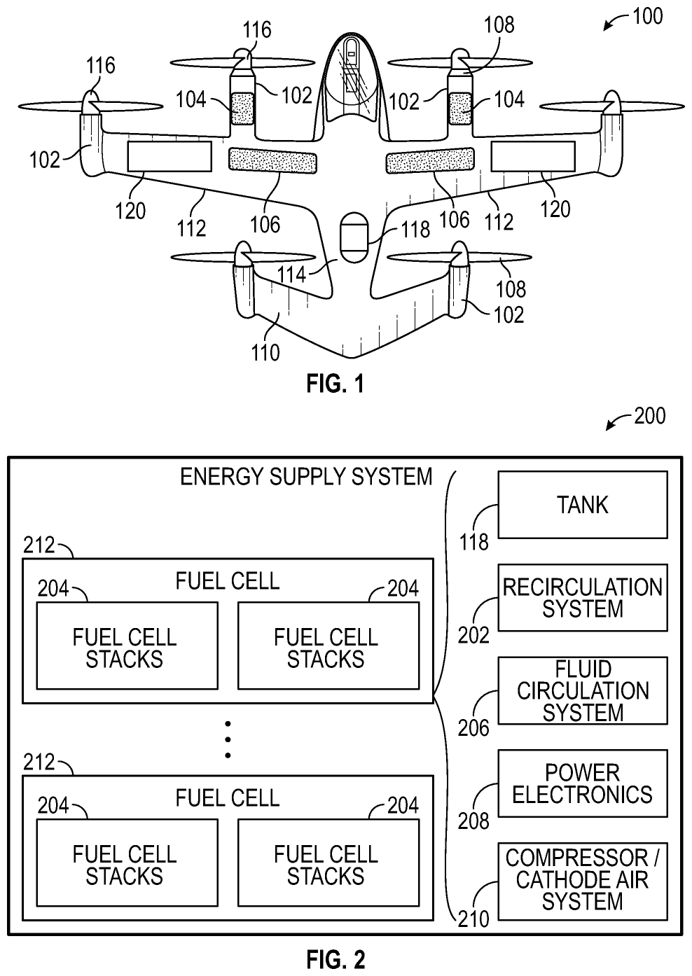

FIG. 2 is a schematic view of an energy supply system 200 for an aerodynamic vehicle (such as an aircraft 100) according to some examples. As shown, the energy supply system 200 includes one or more fuel cells 212. Each fuel cell 212 may include one or more fuel cell stacks 208. Typically associated with a fuel cell 212 are a source of hydrogen such as a liquid or compressed gaseous hydrogen tank 118, a recirculation system 202 for supplying and returning hydrogen to the fuel cell 212, a coolant fluid circulation system 204 for transferring heat, power electronics 206 for regulating delivery of electrical power from the fuel cells 212 during operation and to provide integration of the fuel cells 212 with the electronic infrastructure of the aircraft 100, and a compressor/cathode air system 210 for providing compressed air to the fuel cells 212. The electronic infrastructure can include an energy supply management system, for monitoring and controlling operation of the fuel cells 212.

The fuel cells 212 function to convert chemical energy into electrical energy for supply to the propulsion systems 108. Fuel cells 212 can be arranged and/or distributed about the aircraft 100 in any suitable manner. Fuel cell stacks can be arranged within wings (e.g., inside of an airfoil cavity), inside nacelles, and/or, as discussed below, in any other suitable location on the aircraft.

Also provided may be one or more battery packs for energy storage for start-up, for peak power loads, load following, and also for control and avionics safety in case of a failure in the fuel cell system. In some examples this provides a hybrid fuel cell and battery pack system, in which the propulsion systems 108 are powered jointly or alternately by the fuel cells 212 and battery packs, and in which the fuel cells recharge the battery packs as needed.

The energy supply system 200 can optionally include a heat transfer system (e.g., fluid circulation system 204) and/or that functions to transfer heat from or to various components of the aircraft 100, for example by circulating a working fluid within a fuel cell 212 to remove heat generated during operation, to provide heat for evaporation of liquid hydrogen from the tank 118, or to remove heat from other heat-generating components within the aircraft 100.

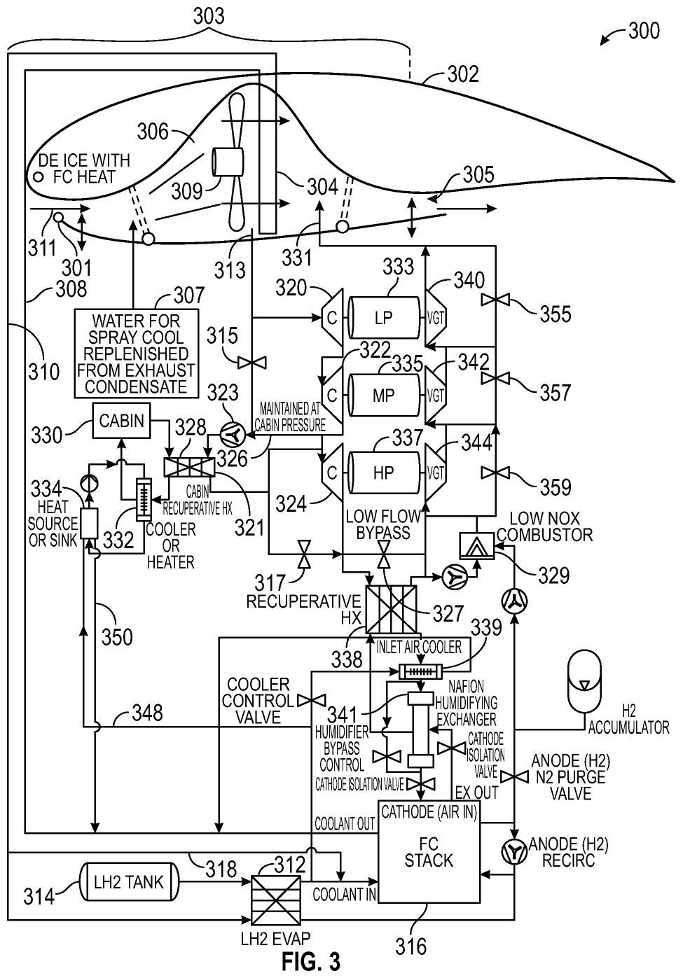

FIG. 3 is a schematic diagram of a fuel cell thermal management system 300 according to some examples. The fuel cell thermal management system 300 in some examples is an energy supply system (such as the energy supply system 200 shown in FIG. 2), such as may be used to provide power to an aircraft. In other examples, the fuel cell thermal management system 300 is a compressor/cathode air system (such as the compressor/cathode air system 210 shown in FIG. 2).

As shown in FIG. 3, in some examples the fuel cell thermal management system 300 includes an airfoil 302 and an integrated air-cooling system 303. The integrated air-cooling system 303 includes a heat exchanger 304, variable-geometry openings, and, in some examples, a fan 309, all contained within a cavity 306. The variable-geometry openings include one or more of a variable-geometry inlet 301 and a variable-geometry outlet 305. The variable-geometry inlet 301 and a variable-geometry outlet 305 are used, either alone or in any combination, to control the amount of cooling airflow 311 flowing through the cavity 306 dependent upon the fuel cell cooling requirements. Although shown in FIG. 3 as located within a wing, it should be noted that the integrated air-cooling system 303 can be located anywhere on the aircraft 100, including the fuselage 114, nacelles 102, and a scoop located on the fuselage 114, nacelles 102, and wings 112.

Air enters the cavity 306 via the variable-geometry inlet 301. The incoming air undergoes a small amount of pressurization at it enter the variable-geometry inlet 301 due to the dynamic pressure. Air is tapped at a location 313 in the cavity 306 where there is a low-speed airflow and used as input air to the compressors.

The heat exchanger 304 can be a radiator, a fin-tube heat exchanger, and so forth. During operation, the cooling airflow 311 enters the cavity 306 and passes across and/or through the heat exchanger 304. A coolant, such as water, glycol, and so forth, flows through a supply line 308 and a return line 310 to cool various components of system 300 as disclosed herein. By way of example, the coolant passes through a heat exchanger where it transfers heat from the fuel cell to the coolant, and the coolant is passed through the heat exchanger 304 where the heat is transferred from the coolant to the cooling airflow 311.

In some examples, the fan 309 is used to draw the cooling airflow 311 into the cavity 306. When cooling requirements are high, for example, while the aircraft 100 is on the ground and not in motion, the fan 309 is used to draw the cooling airflow 311 into the cavity 306 via the variable-geometry inlet 301, which is adjustable in size, and across the heat exchanger 304. While FIG. 3 illustrates fan 309 in front of the heat exchanger 304, it should be noted that the fan 309 may be located aft of the heat exchanger 304.

A water spray system 307, in some examples, sprays coolant, such as water, onto the heat exchanger 304. The water spray system 307 is typically used during ground operations and in other instances when there are additional cooling requirements. In some examples, water for the water spray system 307 is collected from the condensate of the exhaust of a fuel cell stack 316. As such, the water spray system 307 may be self-replenishing. For example, a water accumulation tank may be located proximate a condenser to collect condensate from fuel cell stack 316.

In some examples, the fuel cell thermal management system 300 includes various components for exchanging heat and energy, including heat exchangers 312, 321, and 334, compressors 320, 322 and 324, and variable-geometry turbines (VGT) 340, 342 and 344, the functions of which will be described below. It will be appreciated that not all the components of the fuel cell thermal management system 300 are required in any example, or that the number of any component may vary in the fuel cell thermal management system 300.

The coolant in the fluid loop to and from the heat exchanger 304 in some examples flows through the heat exchanger 312. The coolant heats liquid hydrogen (LH₂) flowing from a liquid hydrogen tank 314. Heating the liquid hydrogen allows the hydrogen to be gasified and warmed to the temperature required by the fuel cell stack 316. Gaseous hydrogen is often desirable in some examples to avoid condensing oxygen or otherwise freezing various components of the fuel cell thermal management system 300. For example, the temperature of liquid hydrogen is approximately negative 250° C. At this temperature, any water vapor or other gasses with a higher condensing or freezing temperature that may contact the hydrogen may liquify or solidify. This may cause blockages within plumbing and potentially other problems during operation of fuel cell thermal management system 300.

The heated hydrogen flows to the fuel cell stack 316. The coolant also flows to the fuel cell stack 316 via a return line 310. After cooling the fuel cell stack 316, the coolant returns to heat exchanger 304 via a return line 308. In addition to, or instead of flowing through heat exchanger 312, in some examples the coolant bypasses the heat exchanger 312 via a bypass line 318. In some examples, the coolant leaving the fuel cell stack 316 goes to the heat exchanger 312 first, before going to the heat exchanger 304, since the outlet of the fuel cell stack 316 typically is the hottest coolant location in the fuel cell thermal management system 300.

As shown in FIG. 3, some examples of the fuel cell thermal management system 300 includes a multi-stage compressor system. In the examples shown in FIG. 3, the multi-stage compressor system is a three-stage compressor system including a low-pressure (LP) stage 333, a medium-pressure (MP) stage 335, and a high-pressure (HP) stage 337. Air flows through a first compressor 320, a low-pressure compressor corresponding to the LP stage 333, a second compressor 322, a medium-pressure compressor corresponding to the MP stage 335, and a third compressor 324, a high-pressure compressor corresponding to the HP stage 337. In each of these three stages the air compressed and consequently heated.

The three-stage compression system manages all altitudes from sea level to high altitude while still delivering 2 to 3 bar of pressurized air to the third compressor 324 at less than the operating temperature of the fuel cell stack 316, which is typically about 70-80 C. If the aircraft 100 is operating at high altitudes, then up to three stages of compression are used. However, at lower altitudes one or more of the compressor stages is bypassed, using the bypass valves 315, 317 at lower altitudes. In other words, bypass valves 315, 317 provide a way to modulate the airflow around those compressor stages that are not needed.

In some examples, air from one or more of the compressors 320, 322, 324 is passed via a duct 326 to a cabin recuperative heat exchanger 328. The cabin recuperative heat exchanger 328 pre-conditions the air used in a cabin 330 of the aircraft 100. Preconditioning the cabin air in some examples includes heating or cooling the air to within a predetermined temperature range before passing the air into a cabin air heater or cooler 332. If necessary, the cabin air heater or cooler 332 either adds or subtracts heat from the preconditioned air to make it usable in as cabin air. For example, a coolant may flow through the cabin air heater or cooler 332 and pass the heat exchanger 334 to heat or cool air flowing into the cabin once the air has been pretreated via the cabin recuperative heat exchanger 321. In some examples, the output of the second compressor 322 is maintained at the required cabin air pressure to provide pressurized cabin air at altitude.

In general, the recuperative heat exchanger 321 reduces the temperature of hot compressor air prior to entering the cabin, and thus reduces the load on the cabin cooling system. Specifically, air from the compressors is run through the recuperative heat exchanger 321 against the air that is exiting the cabin 330. This reduces the amount of heating or cooling needed for the incoming cabin air.

In the unusual event that the recuperated compressor air is too cold (such as at sea level on a cold day) the recuperative heat exchanger 321 reduces demand on the cabin heating system. For high altitude cruise, the compressor outlet air will be too hot for human habitation and the primary purpose of the recuperative heat exchanger 321 is to make the air fit for habitation (or closer to it). This is done while keeping heat within the inlet air compressor/exhaust air turbine cycle (as opposed to, for example, treating the compressor air with a ram-air heat exchanger from external airstream) to reduce shaft power demands on the inlet air compressor/exhaust air turbine system (compressors 320, 322, 324 and turbines 340, 342 and 344). To ensure adequate flow across the recuperative heat exchanger 321, a pump 323 used in some examples The pump 323 is used to overcome frictional losses within the fuel cell thermal management system 300 and to supply adequate air to the recuperative heat exchanger 321.

In addition to, or as an alternative to, heating from the compressors 320, 322, and 324, coolant is received at heat exchanger 334 via a supply line 348 from the heat exchanger 312. The coolant is used in some examples to cool the heat exchanger 334 so that the cabin air can be cooled for passenger comfort. After flowing over the heat exchanger 334, the coolant is returned to the heat exchanger 304 via a return line 350. The use of coolant via the supply line 348 allows the coldest coolant available to be used for conditioning the cabin, since the coolant in other systems may be about 70° C. or 80° C.

The compressors 320, 322, and 324 compress air that is used in part for the fuel cell stack 316. As noted above, the compressors 320, 322, and 324 are part of a three-stage compressor system and allow the fuel cell stack 316 to work at a variety of ambient pressures. For example, at high altitudes compressors 320, 322, 324 compress ambient air, which this is supplied to the fuel cell stack 316. Due to the varying pressures experienced during changes of altitude and speed of the aircraft 100, different stages of compression can be achieved using the three-stage compressor system that includes the compressors 320, 322, and 324.

A bypass valve 327, in some examples, is used to control the flow of air to the fuel cell stack 316. During operations where there are lower pressures and flows to the fuel cell stack 316, the valve 327 is used to allow larger portions of air flowing from the compressors 320, 322, and 324 to bypass the fuel cell stack 316. This bypassed air is sent to a low nitrous oxide (NOx) combustor 329 where it is combusted and the exhaust 331 is expelled through the cavity 306 near the variable-geometry outlet 305 of the airfoil 302.

Another way of controlling the flow to the fuel cell stack 316 is through a series of “backpressure” valves located in the exhaust downstream of the fuel cell stack 316. These bypass valves include a first bypass valve 355, a second bypass valve 357, and a third bypass valve 359. Examples may include one or more, or none of the first bypass valve 355, second bypass valve 357, and third bypass valve 359. These bypass valves 355, 357, 359 allow the bypass of certain turbines that are not needed or not being used, so that compressor stages that are not needed are not left running.

As shown in FIG. 3, the compressors 320, 322, and 324, may be connected to fixed or variable flow or variable geometry turbines (VGT) 340, 342, and 344. It should be noted that the use of variable geometry turbines 340, 342, and 344 alleviates the need for the first bypass valve 355, the second bypass valve 357, and the third bypass valves 359. In addition, the first bypass valve 355, the second bypass valve 357, and the third bypass valves 359 are in some examples to allow air to bypass the three compressor stages. Variable geometry turbines 340, 342, and 344 are driven by fuel cell exhaust gas in some examples, to provide additional work to assist the compressors 320, 322, and 324.

Prior to flowing into the fuel cell stack 316, air may flow through a recuperative heat exchanger 338. The recuperative heat exchanger 338 is used in some examples to precondition air flowing into the fuel cell stack 316. For example, recuperative heat exchanger 338 may cool air having an elevated temperature due to compression to lower the temperature to the operating temperature of the fuel cell stack 316.

The recuperative heat exchanger 138 receives exhaust air from the fuel cell stack 316 after it has passed through a humidifier. The recuperative heat exchanger 338 transfers heat from the air from compressors 320, 322 and 324 to the exhaust air from the fuel cell stack 316, prior to the exhaust air being provided to the turbines 340, 342, and 344.

An inlet air cooler 339 receives chilled coolant from the heat exchanger 312. For example, water, or any other coolant, that is used to vaporize the liquid hydrogen in the heat exchanger 312 is routed through the inlet air cooler 339 and used to cool the air from compressors 320, 322 and 324 before it is supplied to the fuel cell stack 316 to or below the operating temperature of the fuel cell stack 316.

As shown in FIG. 3, the humidity controls are shown around the inlet air cooler 339. These are standard humidity controls 341 that are used to ensure ion exchange within each of the fuel cells. The inlet air being delivered to the fuel cell should have an appropriate level of humidity and this is achieved by recovering some water from the fuel cell exhaust. This is done in a humidifier, which in some examples is a collection of membranes that allow water to migrate from the fuel cell exhaust to the fuel cell inlet. In this way air entering the fuel cell has the proper humidity.

In some examples, the hydrogen cooling provided by the heat exchanger 312 is also used for cooling other systems or components (in addition to the fuel cell stack 316). These systems or components include power electronics, superconducting machines and so forth. The liquid hydrogen from the liquid hydrogen tank 314 is extremely cold, which makes it a good “quality” heat sink. Additional coolant loops are provided in some examples to such systems or components, either from the heat exchanger 312 or as part of one of the other coolant loops, such as the loop including the heat exchanger 304.

### Cabin Air Reuse

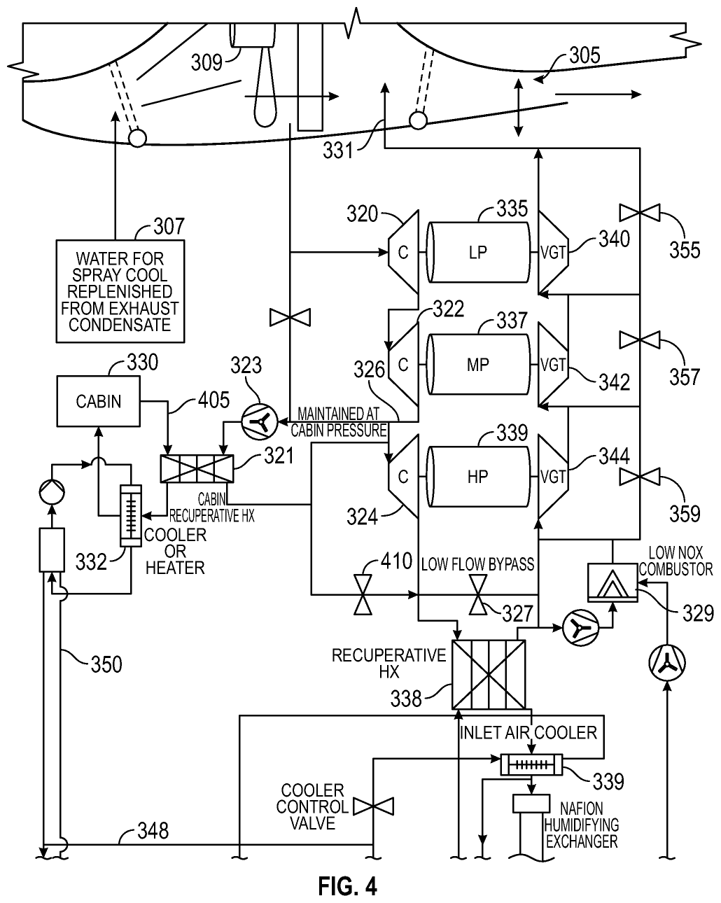

As noted above with respect to FIG. 3, at altitudes where cabin pressurization is required, some examples of the fuel cell thermal management system 300 use the multi-stage compressor system to provide pressurized air for the cabin. Another feature of some examples of the fuel cell thermal management system 300 is a cabin air reuse system 400, shown in FIG. 4. FIG. 4 is a schematic diagram of the cabin air reuse system 400 portion of the fuel cell thermal management system 300 according to some examples.

In general, the cabin air reuse system 400 takes cabin exhaust air (that may contain a small amount of carbon dioxide (CO₂)) and exchanges that air for new air. The cabin exhaust air is bled off or released from the cabin 330 and additional fresh air is added to the cabin. Some examples of the cabin air reuse system 400 take the cabin exhaust air that was released from the cabin 330 and put it back into the fuel cell stack 316. This avoids wasting additional energy compressing air because the air is at least partially compressed. The energy saved by not compressing additional air for the fuel cell stack 316 also reduces the overall heat generated by the fuel cell thermal management system 300, thereby reducing cooling requirements for the fuel cell stack 316. In other words, the compressor does not have to compress additional air for the fuel cell due to the use of conditioned cabin exhaust air in the fuel cell. This serves to reduce the heat generated by the compressor.

Referring to FIG. 4, cabin exhaust air is bled off or released from the cabin 330 via a cabin air bleed mechanism 405. The cabin air bleed mechanism captures the released air as cabin exhaust air. The cabin exhaust air enters the cabin recuperative heat exchanger 321 where it is either heated or cooled, depending on the temperature of the cabin exhaust air, to match the temperature requirements of input air for the fuel cell stack 316. Coming out of the cabin recuperative heat exchanger 321, the cabin exhaust air either goes into the third compressor 324 (based on a position of a bypass valve 410) or bypasses the third compressor 324. The cabin exhaust air is around 0.7 to 0.8 bar, which is the cabin pressurization level. Typically, the cabin exhaust air will need to be at a higher pressure before being used by the fuel cell stack 316.

This is achieved by adjusting the cabin exhaust air go into the third compressor 324 where it is compressed and exits at about 2.5 bar. This adjusts the pressure of the cabin exhaust air to comply with air pressure requirements of input air for the fuel cell stack 316 to obtain conditioned cabin exhaust air. The cabin exhaust air then flows into the recuperative heat exchanger 338. As discussed above, the recuperative heat exchanger 338 is used in some examples to precondition air flowing into the fuel cell stack 316. For example, recuperative heat exchanger 338 may cool air having an elevated temperature due to compression to lower the temperature to the operating temperature of the fuel cell stack 316. In this manner the cabin exhaust air, instead of being released overboard, is reused and passed to the fuel cell stack 316 for its use to avoid having to compress additional air.

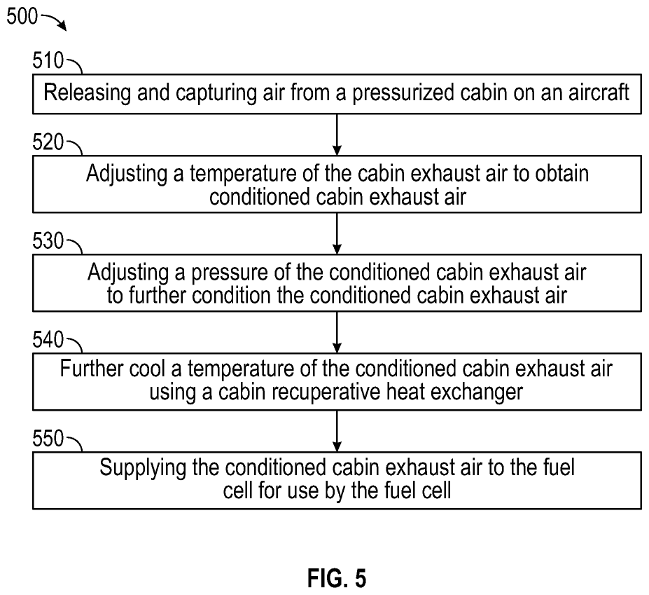

FIG. 5 is a flow diagram illustrating the details of a fuel cell thermal management method according to some examples of this disclosure. The method 500 begins in operation 510 by releasing and capturing air from a pressurized cabin on an aircraft. The released air is captured as cabin exhaust air. The method 500 performs operation 520 by adjusting a pressure of the cabin exhaust air. This obtains conditioned cabin exhaust air that complies with the air pressure requirements of input air for the fuel cell. The fuel cell will have a range of pressures and temperatures that the input air should be at prior to being used by the fuel cell.

The method then performs operation 530 to further condition the conditioned exhaust air by ensuring that a temperature of the cabin exhaust air complies with air temperature requirements of the input air for the fuel cell. In some examples, a cabin recuperative heat exchanger is used to either heat or cool the cabin exhaust air to obtain the conditioned cabin exhaust air. If the temperature of the cabin exhaust air is below the air temperature requirements, then the cabin exhaust air is heated to comply with the air temperature requirements. On the other hand, if the temperature of the cabin exhaust air is above the air temperature requirements, then the cabin exhaust air is cooled to comply with the air temperature requirements.

In some examples, the method 500 includes operation 540 of using a recuperative heat exchanger to cool a temperature of the conditioned cabin exhaust air before being used by the fuel cell. Finally, the method 500 performs operation 550 of supplying the conditioned cabin exhaust air to the fuel cell for use by the fuel cell. This need to not have to compress additional air for the fuel cell serves to reduce the work of the compressor and the fuel cell.

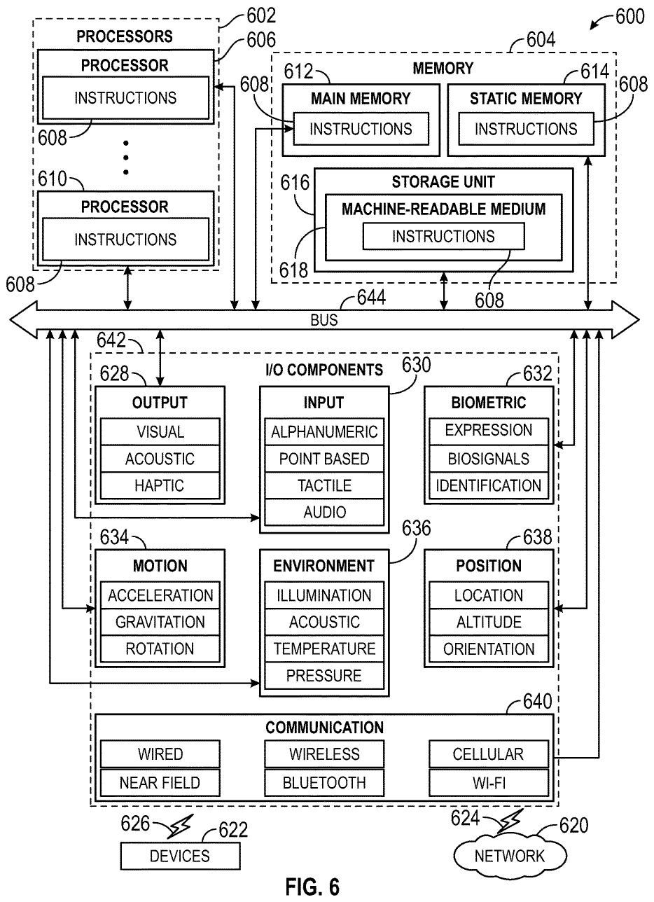

FIG. 6 illustrates a diagrammatic representation of a machine 600 in the form of a computer system within which a set of instructions may be executed for causing the machine to perform any one or more of the methodologies discussed herein, according to an example. For example, the power electronics 206 shown in FIG. 2 may be embodied as the machine 600.

Specifically, FIG. 6 shows a diagrammatic representation of the machine 600 in the example form of a computer system, within which instructions 608 (e.g., software, a program, an application, an applet, an app, or other executable code) for causing the machine 600 to perform any one or more of the methodologies discussed herein may be executed. The instructions 608 transform the general, non-programmed machine 600 into a particular machine 600 programmed to carry out the described and illustrated functions in the manner described. In alternative examples, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 608, sequentially or otherwise, that specify actions to be taken by the machine 600. Further, while only a single machine 600 is illustrated, the term “machine” shall also be taken to include a collection of machines 600 that individually or jointly execute the instructions 608 to perform any one or more of the methodologies discussed herein.

The machine 600 may include processors 602, memory 604, and I/O components 642, which may be configured to communicate with each other such as via a bus 644. In an example, the processors 602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 606 and a processor 610 that may execute the instructions 608. The term “processor” is intended to include multi-core processors that may comprise two or more independent processors (sometimes referred to as “cores”) that may execute instructions contemporaneously. Although FIG. 6 shows multiple processors 602, the machine 600 may include a single processor with a single core, a single processor with multiple cores (e.g., a multi-core processor), multiple processors with a single core, multiple processors with multiples cores, or any combination thereof.

The memory 604 may include a main memory 612, a static memory 614, and a storage unit 616, both accessible to the processors 602 such as via the bus 644. The main memory 604, the static memory 614, and storage unit 616 store the instructions 608 embodying any one or more of the methodologies or functions described herein. The instructions 608 may also reside, completely or partially, within the main memory 612, within the static memory 614, within machine-readable medium 618 within the storage unit 616, within at least one of the processors 602 (e.g., within the processor's cache memory), or any suitable combination thereof, during execution thereof by the machine 600.

The I/O components 642 may include a wide variety of components to receive input, provide output, produce output, transmit information, exchange information, capture measurements, and so on. The specific I/O components 642 that are included in a particular machine will depend on the type of machine. For example, portable machines such as mobile phones will likely include a touch input device or other such input mechanisms, while a headless server machine will likely not include such a touch input device. It will be appreciated that the I/O components 642 may include many other components that are not shown in FIG. 6. The I/O components 642 are grouped according to functionality merely for simplifying the following discussion and the grouping is in no way limiting. In various examples, the I/O components 642 may include output components 628 and input components 630. The output components 628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 630 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O) components 642 may include biometric components 632, motion components 634, environmental components 636, or position components 638, among a wide array of other components. For example, the biometric components 632 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 634 may include acceleration sensor components (e.g., accelerometer), gravitation sensor components, rotation sensor components (e.g., gyroscope), and so forth. The environmental components 636 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 638 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 642 may include communication components 640 operable to couple the machine 600 to a network 620 or devices 622 via a coupling 624 and a coupling 626, respectively. For example, the communication components 640 may include a network interface component or another suitable device to interface with the network 620. In further examples, the communication components 640 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 622 may be another machine or any of a wide variety of peripheral devices (e.g., a peripheral device coupled via a USB).

Moreover, the communication components 640 may detect identifiers or include components operable to detect identifiers. For example, the communication components 640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., memory 604, main memory 612, static memory 614, and/or memory of the processors 602) and/or storage unit 616 may store one or more sets of instructions and data structures (e.g., software) embodying or utilized by any one or more of the methodologies or functions described herein. These instructions (e.g., the instructions 608), when executed by processors 602, cause various operations to implement the disclosed examples.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data in a non-transitory manner and that can be read by one or more processors. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various examples, one or more portions of the network 620 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 620 or a portion of the network 620 may include a wireless or cellular network, and the coupling 624 may be a Code Division Multiple Access (CDMA) connection, a Global System for Mobile communications (GSM) connection, or another type of cellular or wireless coupling. In this example, the coupling 624 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 608 may be transmitted or received over the network 620 using a transmission medium via a network interface device (e.g., a network interface component included in the communication components 640) and utilizing any one of a number of well-known transfer protocols (e.g., hypertext transfer protocol (HTTP)). Similarly, the instructions 608 may be transmitted or received using a transmission medium via the coupling 626 (e.g., a peer-to-peer coupling) to the devices 622. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 608 for execution by the machine 600, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Additional Notes

The following, non-limited examples, detail certain aspects of the present subject matter to solve the challenges and provide the benefits discussed herein, among others.

Example 1 is a method of thermal management of a fuel cell on an aircraft, the aircraft having a pressurized cabin, the method comprising: releasing air from the pressurized cabin and capturing the released air as cabin exhaust air; adjusting a pressure of the cabin exhaust air to comply with air pressure requirements of input air for the fuel cell to obtain conditioned cabin exhaust air; and supplying the conditioned cabin exhaust air to the fuel cell for use in the fuel cell to reduce cooling requirements of the fuel cell.

In Example 2, the subject matter of Example 1 includes, ensuring that a temperature of the cabin exhaust air complies with air temperature requirements of the input air for the fuel cell to obtain the conditioned cabin exhaust air.

In Example 3, the subject matter of Example 2 includes, using a cabin recuperative heat exchanger to either cool or heat the cabin exhaust air to obtain the conditioned cabin exhaust air.

In Example 4, the subject matter of Example 3 includes, determining that the temperature of the cabin exhaust air is lower than the air temperature requirements for the input air for the fuel cell; and, heating the cabin exhaust air so that the temperature of the cabin exhaust air meets the air temperature requirements of the input air for the fuel cell.

In Example 5, the subject matter of Examples 3-4 includes, determining that the temperature of the cabin exhaust air is higher than the air temperature requirements for the input air for the fuel cell; and, cooling the cabin exhaust air so that the temperature of the cabin exhaust air meets the air temperature requirements of the input air for the fuel cell.

In Example 6, the subject matter of Examples 1-5 includes, where adjusting a pressure of the cabin exhaust air to comply with air pressure requirements of input air for the fuel cell further comprises compressing and then cooling the cabin exhaust air to obtain the conditioned cabin exhaust air.

In Example 7, the subject matter of Example 6 includes, wherein the cabin exhaust air is compressed using a compressor on the aircraft and wherein the compressor also provides compressed air to the fuel cell.

In Example 8, the subject matter of Example 7 includes, wherein the compressor does not have to compress additional air for the fuel cell due to the use of conditioned cabin exhaust air in the fuel cell, thereby reducing heat generated by the compressor.

In Example 9, the subject matter of Examples 7-8 includes, using a three-stage compressor to compress the cabin exhaust air to obtain the conditioned cabin exhaust air, wherein the three-stage compressor includes a low-pressure compressor, a medium-pressure compressor, and a high-pressure compressor.

In Example 10, the subject matter of Example 9 includes, using a recuperative heat exchanger to cool a temperature of the conditioned cabin exhaust air before being used by the fuel cell.

Example 11 is a fuel cell thermal management system for an aircraft, comprising: an integrated air-cooling system having a heat exchanger located in a cavity on the aircraft; a fuel cell in fluid communication with the heat exchanger for transferring heat from the fuel cell to the heat exchanger; at least one compressor on the aircraft for compressing air prior to the air entering the fuel cell; and a cabin air bleed mechanism for releasing and capturing cabin air from a pressurized cabin of the aircraft and using this cabin exhaust air as input air to the fuel cell.

In Example 12, the subject matter of Example 11 includes, a cabin recuperative heat exchanger for either heating or cooling the cabin exhaust air such that a temperature of the cabin exhaust air approximately matches air temperature requirements for input air to the fuel cell.

In Example 13, the subject matter of Examples 11-12 includes, wherein the at least one compressor is a three-stage compressor system having a first low-pressure compressor, a second medium-pressure compressor, and a third high-pressure compressor.

In Example 14, the subject matter of Example 13 includes, bar for use as the input air to the fuel cell.

In Example 15, the subject matter of Examples 13-14 includes, a recuperative heat exchanger for cooling a temperature of the cabin exhaust air, after compression by the three-stage compressor system and before being used by the fuel cell.

In Example 16, the subject matter of Examples 11-15 includes, wherein the integrated air-cooling system further comprises: a variable-geometry outlet at one end of the cavity for controlling an amount of cooling airflow passing through the cavity and over the heat exchanger; a fan located in the cavity; wherein the integrated air-cooling system is located on one or more of: (a) a wing of the aircraft; (b) a fuselage of the aircraft; (c) a nacelle of the aircraft.

In Example 17, the subject matter of Examples 11-16 includes, a water spray system arranged to spray water onto surfaces of the heat exchanger.

In Example 18, the subject matter of Example 17 includes, a water accumulation tank that provides water to the water spray system and collects the water from exhaust of the fuel cell.

Example 19 is a method for reusing cabin exhaust air from pressurized cabin of an aircraft, comprising: releasing and capturing the cabin exhaust air from the pressurized cabin; conditioning the cabin exhaust air to adjust its pressure and temperature to obtain conditioned cabin exhaust air and to comply with air pressure requirements and air temperature requirements of input air for a fuel cell located on the aircraft; and supplying the conditioned cabin exhaust air to the fuel cell for use by the fuel cell.

In Example 20, the subject matter of Example 19 includes, increasing the pressure of the cabin exhaust air by using a high-pressure compressor on the aircraft, wherein the high-pressure compressor is part of a three-stage compressor system also having a low-pressure compressor and a medium-pressure compressor.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Examples of the system and method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the examples of the invention disclosed herein without departing from the scope of this invention defined in the following claims.

The above-detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of thermal management of a fuel cell on an aircraft, the aircraft having a pressurized cabin, the method comprising:
releasing air from the pressurized cabin and capturing the released air as cabin exhaust air;
adjusting a pressure of the cabin exhaust air to comply with air pressure requirements of input air for the fuel cell to obtain conditioned cabin exhaust air; and
supplying the conditioned cabin exhaust air to the fuel cell for use in the fuel cell to reduce cooling requirements of the fuel cell.

2. The method of claim 1, further comprising ensuring that a temperature of the cabin exhaust air complies with air temperature requirements of the input air for the fuel cell to obtain the conditioned cabin exhaust air.

3. The method of claim 2, further comprising using a cabin recuperative heat exchanger to either cool or heat the cabin exhaust air to obtain the conditioned cabin exhaust air.

4. The method of claim 3, further comprising:
determining that the temperature of the cabin exhaust air is lower than the air temperature requirements for the input air for the fuel cell; and,
heating the cabin exhaust air so that the temperature of the cabin exhaust air meets the air temperature requirements of the input air for the fuel cell.

5. The method of claim 3, further comprising:
determining that the temperature of the cabin exhaust air is higher than the air temperature requirements for the input air for the fuel cell; and,
cooling the cabin exhaust air so that the temperature of the cabin exhaust air meets the air temperature requirements of the input air for the fuel cell.

6. The method of claim 1, where adjusting a pressure of the cabin exhaust air to comply with air pressure requirements of input air for the fuel cell further comprises compressing and then cooling the cabin exhaust air to obtain the conditioned cabin exhaust air.

7. The method of claim 6, wherein the cabin exhaust air is compressed using a compressor on the aircraft and wherein the compressor also provides compressed air to the fuel cell.

8. The method of claim 7, wherein the compressor does not have to compress additional air for the fuel cell due to the use of conditioned cabin exhaust air in the fuel cell, thereby reducing heat generated by the compressor.

9. The method of claim 7, further comprising using a three-stage compressor to compress the cabin exhaust air to obtain the conditioned cabin exhaust air, wherein the three-stage compressor includes a low-pressure compressor, a medium-pressure compressor, and a high-pressure compressor.

10. The method of claim 9, further comprising using a recuperative heat exchanger to cool a temperature of the conditioned cabin exhaust air before being used by the fuel cell.

11. A fuel cell thermal management system for an aircraft, comprising:
an integrated air-cooling system having a heat exchanger located in a cavity on the aircraft;
a fuel cell in fluid communication with the heat exchanger for transferring heat from the fuel cell to the heat exchanger;
at least one compressor on the aircraft for compressing air prior to the air entering the fuel cell; and
a cabin air bleed mechanism for releasing and capturing cabin air from a pressurized cabin of the aircraft and using this cabin exhaust air as input air to the fuel cell.

12. The fuel cell thermal management system of claim 11, further comprising a cabin recuperative heat exchanger for either heating or cooling the cabin exhaust air such that a temperature of the cabin exhaust air approximately matches air temperature requirements for input air to the fuel cell.

13. The fuel cell thermal management system of claim 11, wherein the at least one compressor is a three-stage compressor system having a first low-pressure compressor, a second medium-pressure compressor, and a third high-pressure compressor.

14. The fuel cell thermal management system of claim 13 wherein the three-stage compressor system increases a pressure of the cabin exhaust air from approximately 0.7 to 0.8 bar to approximately 2.5 bar for use as the input air to the fuel cell.

15. The fuel cell thermal management system of claim 13, further comprising a recuperative heat exchanger for cooling a temperature of the cabin exhaust air, after compression by the three-stage compressor system and before being used by the fuel cell.

16. The fuel cell thermal management system of claim 11, wherein the integrated air-cooling system further comprises:
a variable-geometry outlet at one end of the cavity for controlling an amount of cooling airflow passing through the cavity and over the heat exchanger;
a fan located in the cavity;
wherein the integrated air-cooling system is located on one or more of: (a) a wing of the aircraft; (b) a fuselage of the aircraft; (c) a nacelle of the aircraft.

17. The fuel cell thermal management system of claim 11, further comprising a water spray system arranged to spray water onto surfaces of the heat exchanger.

18. The fuel cell thermal management system of claim 17, further comprising a water accumulation tank that provides water to the water spray system and collects the water from exhaust of the fuel cell.

19. A method for reusing cabin exhaust air from pressurized cabin of an aircraft, comprising:
releasing and capturing the cabin exhaust air from the pressurized cabin;
conditioning the cabin exhaust air to adjust its pressure and temperature to obtain conditioned cabin exhaust air and to comply with air pressure requirements and air temperature requirements of input air for a fuel cell located on the aircraft; and
supplying the conditioned cabin exhaust air to the fuel cell for use by the fuel cell.

20. The method of claim 19, further comprising increasing the pressure of the cabin exhaust air by using a high-pressure compressor on the aircraft, wherein the high-pressure compressor is part of a three-stage compressor system also having a low-pressure compressor and a medium-pressure compressor.
